(19) United States
(12) Patent Application Publication
(10) Pub. No.: US 2013/0098492 A1
(43) Pub. Date: Apr. 25, 2013

(54) WATER HAMMER ARRESTER

(71) Applicants: James COSLEY, Santa Clarita, CA (US); Jacob CHASE, Canyon Country, CA (US)

(72) Inventors: James COSLEY, Santa Clarita, CA (US); Jacob CHASE, Canyon Country, CA (US)

(73) Assignee: KING BROTHERS INDUSTRIES, INC., Valencia, CA (US)

(21) Appl. No.: 13/280,172

(22) Filed: Oct. 24, 2011

(51) Int. Cl. F16L 55/045; B32B 37/04

(52) U.S. Cl. 138/31; 156/70

(57) ABSTRACT

A water hammer arrester and a process for making a water hammer arrester. The arrester includes a includes a cylindrical tube that contains a sliding piston separating the interior into a gas portion and a liquid portion. The gas portion is enclosed by a cap. The liquid portion has a pipe fitting for connection to a liquid-carrying pipe. The process includes assembling the piston, cylinder, fitting, and cap together outside of a pressured chamber used to charge the gas portion. A pressure chamber receives the cap and open end of the cylinder, and tabs around the cap allow fluid flow into the gas portion of the cylinder. Increasing gas pressure in the pressure chamber simultaneously increases gas pressure inside the gas portion. At this raised pressure, an ultrasonic welding horn engages the cap and/or cylinder to weld the two together trapping the gas therein under pressure.

### FIELD OF THE INVENTION

The present invention relates to damping a shock wave that sometimes appears in fluids flowing through pipes. More particularly, the present invention relates to a water hammer arrester used to damp the shock wave that sometimes appears in water flowing inside residential and commercial plumbing.

### BACKGROUND

Water hammer is a specific plumbing noise that most everyone is familiar with. It occurs when someone shuts off a tap and water flow is stopped suddenly so that the fast-moving water in the plumbing is blocked by a closed valve. Similarly, a residential dishwasher or washing machine in operation feeds water to the wash tank at a high volume and flow rate, and when the washer detects a sufficient water level in the tank, a valve is shut off suddenly blocking the water flow. Due to the momentum in the flowing water, the sudden blockage of water flow creates a shock wave that travels at the speed of sound along the pipe until it impacts an elbow or bend in the pipe which causes a pinging or hammering noise. The shock wave may get reflected back along the same section of pipe multiple times until its energy is dissipated, but making more pinging noises along the way. These sorts of shock waves traveling through the plumbing is detrimental and damaging to the plumbing as well as being a noisy irritation for the resident in the home or apartment.

There have been efforts to reduce or eliminate the water hammer effect. One such device is a water hammer arrester, which is a device added to the pipeline. Typically, the water hammer arrester has a gas pocket trapped on one side of a piston sliding inside a tubular housing, and the opposite side of the piston receives the water flowing through the pipe. As a shock wave propagates through the pipe, enters the arrester, and impacts the piston, the piston is displaced against the gas pocket compressing it and thereby absorbing some of the energy of the shock wave. The energy from the water hammer is thus diminished or dampened.

Some examples of such water hammers include: U.S. Pat. No. 3,422,853 (J. H. Schmid); U.S. Pat. No. 4,819,698 (Ismert); 5,385,172 (Perrott et al.); U.S. Pat. No. 6,095,195 (Park et al.); U.S. Pat. No. 6,154,961 (Park et al.); U.S. Pat. No. 6,539,976 (Whiteside); and U.S. Patent Application Publication No. 2011/0036437 (McCoy et al.).

### SUMMARY OF THE INVENTION

The present invention in various preferred embodiments is directed to a process for making a water hammer arrester, and an apparatus for arresting water hammer effects in piping. The present invention includes processes for making a water hammer arrester for damping a shock wave propagating inside a liquid medium within a pipe, a preferred process comprising: providing a carrier slidable on a frame; providing a pressure chamber having first and second ends at one end of the frame; providing a hollow cylinder with a gas end and a liquid end, a piston, and a cap having tabs; assembling the hollow cylinder, piston, and cap together to create an arrester assembly outside of the pressure chamber, wherein the piston is slidable inside the cylinder and the cap is disposed over the gas end of the cylinder with a slight gap supported by the tabs, wherein a plenum chamber is formed between the cap and the piston; providing an ultrasonic welding horn disposed at the first end of the pressure chamber; wherein the carrier receives the arrester assembly therein; moving the carrier with the arrester assembly toward the second end of the pressure chamber such that the gas end and only a portion of the arrester assembly and the cap are inserted into the pressure chamber; increasing the pressure inside the pressure chamber to a pressure higher than outside the pressure chamber wherein the pressure inside the plenum chamber is increased concurrently; advancing the ultrasonic welding horn to engage at least one of the cap and the arrester cylinder, and forcing the cap to abut the gas end of the cylinder and closing the gap therebetween; ultrasonically welding the cap to the cylinder of the arrester sealing the plenum chamber closed at the pressure of the pressure chamber; and withdrawing the carrier to retract the arrester assembly out of the pressure chamber.

The present invention process optionally includes snap fitting a pipe fitting to the liquid end of the cylinder for connecting the arrester to the pipe, and mounting at least one O-ring to the piston outside of the pressure chamber. The ambient pressure inside the plenum chamber is preferably the same as the ambient pressure inside the pressure chamber when the gas end, the portion of the arrester assembly, and the cap are inserted into the pressure chamber. Furthermore, the ambient pressure inside the plenum chamber is the same as the ambient pressure inside the pressure chamber, and is ≧about 60 psi.

The present invention also contemplates a water hammer arrester for damping a shock wave in a liquid-carrying pipe, comprising a hollow cylinder having a gas end and a liquid end; a piston slidable within the hollow cylinder dividing the interior of the cylinder to a gas section in communication with the gas end and a liquid section; an O-ring disposed on the piston to seal leakage of gas and liquid from the gas section and the liquid section; a plug shaped cap covering the gas end, wherein the piston, cap, and cylinder wall form a sealed plenum chamber at the gas section; an ultrasonic weld joining the cap to the gas end of the cylinder and sealing closed the gas end to any gas leak; at least one of nitrogen, air, or carbon dioxide, contained inside the plenum chamber at a pressure of ≧about 60 psi; and a fitting extending from the liquid end having a passage therein in communication with the liquid section, and connected to the pipe.

The water hammer arrester may have a fitting that is made from a thermoplastic polymer and is adapted for standard ½ inch copper tubing size pipes. The fitting and arrester cylinder may be made from different polymer-based materials so that the polymer fitting can be chemically bonded to existing polymer or CPVC-type valves, fittings, joints, etc. The 60 psi or higher gas pressure inside the arrester dampens the water hammer effect more quickly and effectively.

### BRIEF DESCRIPTION OF THE DRAWINGS

The present invention will be understood and appreciated more fully from the following detailed description, taken in conjunction with the drawings in which:

FIG. 1 is an exploded view of a preferred embodiment water hammer arrester.

FIG. 2 is a assembled view of the arrester of FIG. 1, wherein the cap is resting on the tabs with a gap prior to the ultrasonic weld.

FIG. 3 is a cutaway view of the arrester of FIG. 1 wherein the piston has been displaced away from the pipe fitting.

FIGS. 4-9 depict the process for charging the arrester with a gas up to a desired pressure and then ultrasonically welding the cap to the arrester assembly while maintaining the pressure.

It will be appreciated by persons skilled in the art that the present invention is not limited by what has been particularly shown and described hereinabove. Rather, the scope of the present invention includes both combinations and subcombinations of the various features described hereinabove, as well as modifications and variations thereof which would occur to a person of ordinary skill in the art upon reading the following description and which are not in the prior art.

### DETAILED DESCRIPTION OF THE PREFERRED EMBODIMENTS

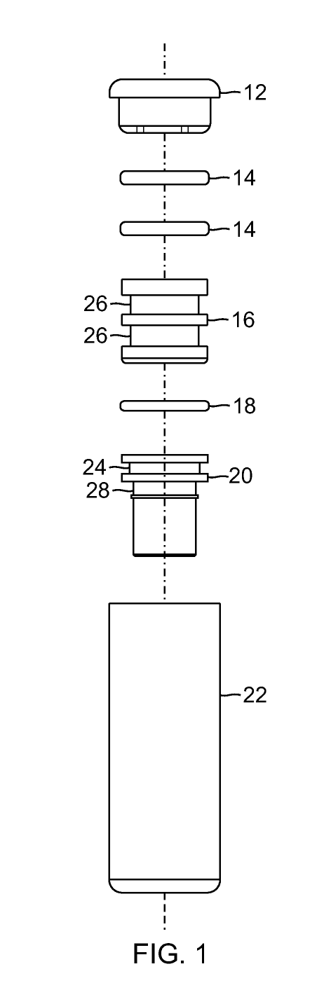

FIG. 1 is an exploded view of a preferred embodiment of the present invention water hammer arrester or damper. The water hammer arrester 10 is preferably used with a water carrying pipe and plumbing systems found in residences and commercial buildings, but other liquid carrying applications are contemplated. The arrester 10 uses a trapped gas in conjunction with a piston to dampen or dissipate the momentum from a shock wave that causes the water hammer effect.

The preferred embodiment arrester 10 has a tubular shaped, cylindrical housing 22 with an open, gas end to be covered by a plug-shaped cap 12. Sliding through the gas end and into the hollow interior of the housing 12 is an optional pipe fitting 20, and an O-ring 18 that pass through the opposite, liquid end of the housing 12, where the lip of the port at the liquid end seats against a barbed connection or detent 24 of the pipe fitting 20. The pipe fitting 20 preferably extends out the gas end of the housing 22 through this optional port. A piston 16 also slides into the interior of the housing 22 where one or more optional O-rings 14 seat into respective detents 26.

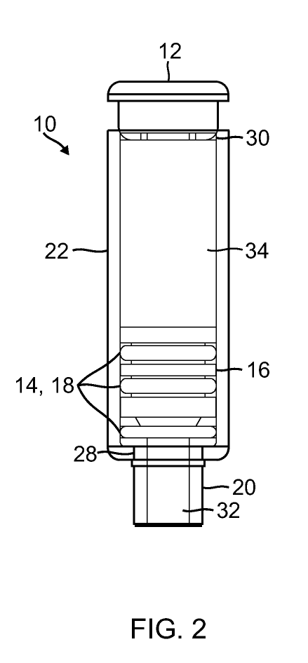

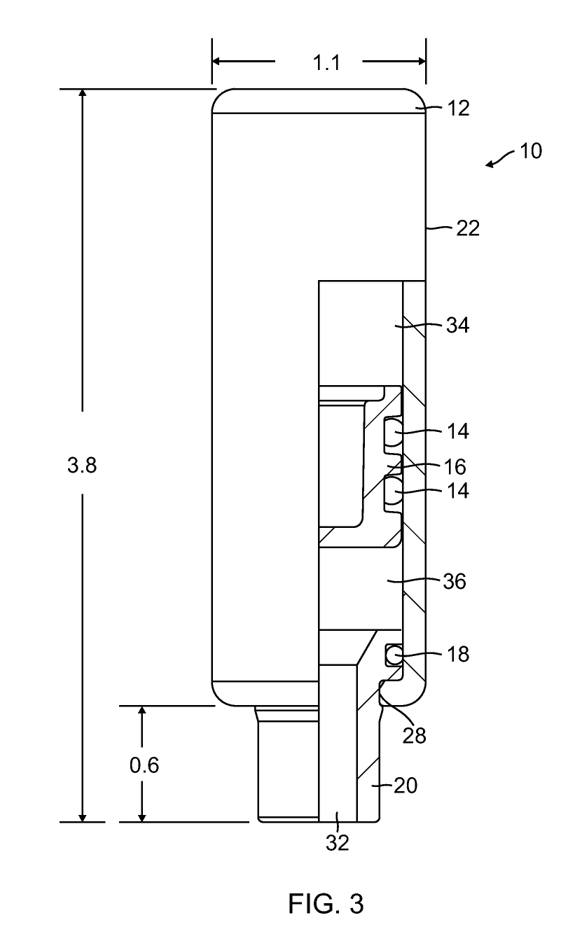

Pipe fitting 20 has a further optional detent 28. As seen in FIGS. 2 and 3, the bottom of the housing 22 in the preferred embodiment includes an opening through which the fitting 20 protrudes. The edge or lip of the opening in the housing 22 snap fits into the detent 28 thus tightly securing the fitting 20 to the housing 22 while assuring easy assembly without need for welding, bonding, screw threads, etc. The fitting 20 is used to adapt the arrester 10 to fit to industry standard pipe diameters. In the embodiment shown, the fitting 20 is made from CPVC (Chlorinated Polyvinyl Chloride) and designed to be glued into a CTS (Copper Tube Size) socket typically ranging from ¼ inch to 2 inch diameters, for use with working pressures of 400 psi at 73 degrees F. for cold water and 100 psi at 180 degrees F. for hot water. But other connections are contemplated including PEX type pipes (i.e., cross-linked polyethylene couplings, joints, and tubing used in plumbing and hydronic radiant heating systems) ranging in diameter sizes from ¼ inch to 4 inch with ½ inch, ¾ inch and 1 inch being the most preferable sizes.

The fitting 20 has an internal passage or conduit 32 (seen in FIG. 3) that conducts water from the pipe to which the arrester is connected into the interior of the arrester 10. The optional O-ring 18 on the fitting 20 helps seal out any potential water leakage from between the lip of the housing port and the detent 28. In various alternative embodiments, the fitting 20 may extend from the side of the arrester at the liquid end for an elbow joint arrangement or a T-shaped arrangement. In such embodiments, the fitting may be a discrete component that is welded, glued, or otherwise mechanically attached (e.g., threaded, snap fit, interference fit, etc.) to the housing, or the fitting may be formed or molded as an integral part of the housing at or proximate to the liquid end.

The present preferred embodiment fitting 20 is a separate, discrete part from the cylindrical housing 22, and assembled to it after the cylindrical housing is formed, typically by injection molding. As such, the fitting 20 can be and is preferably made from a different material than the housing 22. The fitting 20 as mentioned above is made from CPVC to allow for bonding to a standard CTS socket, while the housing and other components of the arrester 10 is preferably made from acetal for their engineering characteristics. The present invention arrester 10 and its pipe fitting 20 can thus be made from two different resins, polymers, or materials. As a result, the selection of the pipe fitting 20 material, size, and shape can be chosen for its intended use in connecting to a plumbing socket, joint, fitting, etc., while the material for the housing and components may be chosen for its engineering characteristics.

FIG. 2 shows the cap 12 resting on a plurality of tabs 30 disposed around the circumference of the cap leaving gaps between the tabs 30 and/or slight gaps between the cap 12 and the open, gas end of the housing 22. A gas containing plenum chamber 34 is created between the cap 12, the walls of the housing 22, and the piston 16. As arranged, by virtue of the gaps by and around the cap 12, the ambient pressure is the same as the pressure inside the plenum chamber 34. The tabs 30 may alternatively take the form of spaced-apart blocks, bumps, grooves, slots, through-holes, pits, cut outs, and the like.

FIG. 3 provides a cutaway view of the preferred embodiment arrester 10 in its completely assembled form. The cap 12 has been welded to the housing 22 and pressurized gas is trapped inside the plenum chamber 34. In FIG. 3, the piston 16 has moved away from the fitting 20. Thus, the piston 16 divides and separates the interior of the arrester 10 into a gas section or chamber 34 and a liquid section or chamber 36. The water from the plumbing system is in fluid communication with the liquid chamber 36 via internal passage or conduit 32 in the fitting. O-rings 14 prevent leakage of gas into the liquid section or vice versa.

The arrangement in FIG. 3 allows the piston 16 to translate inside the housing 22 for the damping effect. To enhance this action, the material preferably used for the housing is a class of thermoplastic polymers known as acetal (i.e., polyoxymethylene). The O-rings 14 are made from EPDM (ethylene propylene diene monomer rubber). Empirical observations show that this combination of materials provides an effective gas-liquid seal while maintaining self-lubrication, low surface friction, enhanced dimensional stability (for exposure to hot or cold water), and enhanced wear resistance. Nylon, PBT (polybutylene terephthalate), and the like may be used instead of acetal for the housing, cap, piston, etc.

Furthermore, through empirical observations, the gas contained inside the plenum chamber 34 in the static, unconnected (from the plumbing) state of the arrester 10 is preferably at about 60 psi at room temperature, or greater than 60 psi. The gas used in the plenum chamber 34 is preferably ambient air, carbon-dioxide, but more preferably nitrogen.

The 60 psi gas pressure is preferred because it is a common line pressure for the plumbing in residential homes. If the gas pressure inside the water hammer arrestor 10 is less than the line pressure, the piston 16 moves up and compresses the gas until the gas and line pressures are equal. By choosing a gas pressure closer to the line pressure, the arrester 10 insures that the piston 16 is using more of the full length of the arrestor for the shock absorber effect. In contrast, if, say, 40 psi were used for the fill pressure inside gas chamber 34, the piston 16 would move up approximately 0.557″ to allow it to come to equilibrium with a 60 psi line. This is approximately half the total available stroke of the piston 16 inside the cylinder housing 22 (based on the dimensions shown in FIG. 3).

Because of the higher gas plenum chamber pressures in the present invention arrester 10, the piston 16 is displaced more due to the governing equations of the gas-liquid system. A higher initial pressure means more “pre-shock” volume inside the housing cylinder. Because the quantity (Pressure)×(Volume) is approximately a constant in the gas side of this system, a higher “pre-shock” volume results in a “softer” gas spring encountered by the water hammer. In other words, the system pressure changes less for a given displacement of the piston 16 if the initial plenum chamber 34 charge is 60 psi (for a 60+ psi line pressure). Use of the water hammer arrester 10 in a common residential plumbing system therefore keeps the water pressure below 150 psi during pressure surges caused by the water hammer.

Furthermore, the greater displacement of the piston 16 and softer “gas spring” in the present invention arrester result in more energy of the water hammer being absorbed or dissipated. By the same token, a softer gas spring (as compared to a rigid gas spring) further minimizes the possibility of reflecting the shock wave back through the pipe, which would prolong the water hammer effect. So as a result of the longer piston travel and the softer gas spring, the water hammer effect is very quickly damped and eliminated, avoiding damage to the plumbing system.

FIG. 3 shows the preferred dimensions of a residential plumbing arrester 10, at 3.8 inch high, 1.1 inch diameter, and 0.6 inch extension for the CTS CPVC fitting 20 with a ½ inch diameter. These dimensions have been found to meet the engineering, materials, pressure, and damping requirements specified above, yet all contained within a compact package.

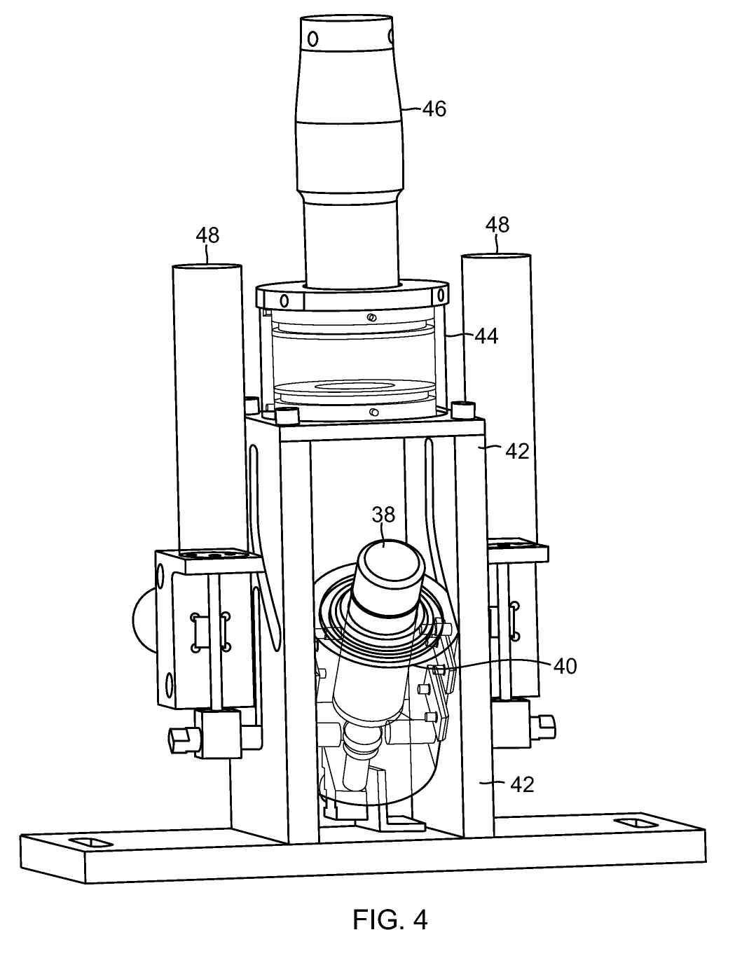

FIGS. 4-9 depict a preferred embodiment process and machine tool for charging the gas inside the plenum chamber 34 and ultrasonically welding the cap 12 to the housing 22 while maintaining the elevated pressure inside the plenum chamber 34.

FIG. 4 shows a water hammer assembly 38 placed in a carrier 40 of an ultrasonic welding machine tool. The carrier 40 translates along a rectangular frame 42 to move the water hammer assembly 38 toward or away from a pressure chamber 44 that is disposed at one end of the frame 42. Mounted atop the pressure chamber 44 is an ultrasonic welding horn or sonotrode 46. The horn 46 is part of an ultrasonic welder (not shown), which uses high frequency ultrasonic vibrations that are conducted to the workpieces to be welded together. From a combination of pressure on the workpieces and the ultrasonic vibrations (in the range of 15-70 kHz for thermoplastics), the workpieces melt and bond together without need for glue, screws, mechanical joints, etc.

Dual actuation pneumatic or hydraulic cylinders 48 move the carrier 40 up and down along the frame 42. The entire ultrasonic welding tool using actuators, motors, pumps, etc., can be controlled by a programmable pc or microprocessor (not shown).

Notably, the entire ultrasonic welding tool is located at standard ambient temperature and pressure on the shop floor. Before welding, the water hammer arrester assembly 38 is hand or machine assembled under these standard atmospheric conditions, and when assembled, the assembly 38 appears as depicted in FIG. 2. The arrester assembly 38 is then manually or automatically placed into the carrier 40.

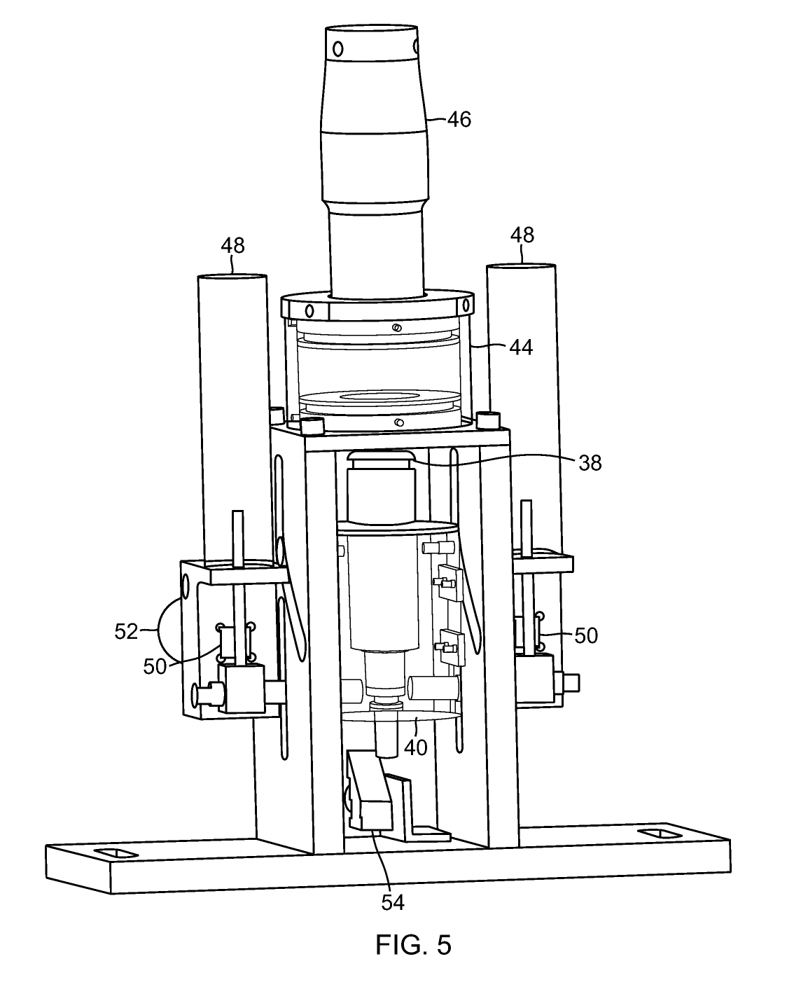

In FIG. 5, actuation cylinders 48 on each side lift carrier 40 upwards toward the gas charging pressure chamber 44. The arrester assembly 38 mounted to the carrier 40 is rotated into coaxial alignment with the ultrasonic welding horn 46 and the pressure chamber 44.

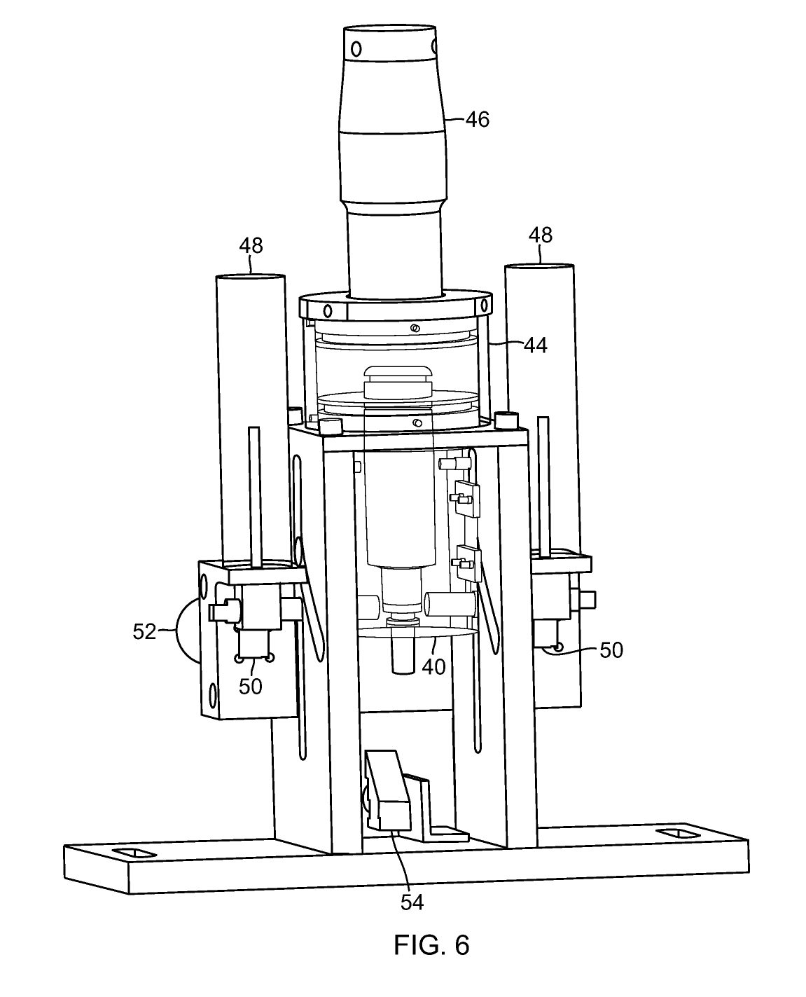

FIG. 6 shows the pressure charging process of the arrester assembly 38. Only a portion of the gas end, including the cap of the arrester assembly 38, is inserted into the pressure chamber 44 of the tool. There is a pressure-tight seal where the gas end of the arrester assembly 38 passes through the floor of the pressure chamber 44. In this position, registration cylinders 52 push locks 50 into position to keep any gas pressure (from the pressure chamber) or force (from the ultrasonic weld horn) from moving the arrester assembly and carrier 50 downward and back out of the pressure chamber 44.

Pressure chamber 44 is pressurized and the plenum chamber 34 inside the arrester assembly 38 is simultaneously pressurized. This occurs because the cap 12 is supported and spaced apart from the housing 22 (as in FIG. 2) by the tabs 30 at the base of the cap 12, and there are gaps between the tabs 30, so pressure inside the arrester plenum chamber 34 equalizes with the pressure inside the pressure chamber 44 of the machine tool. It is preferred that the pressure inside the pressure chamber of the tool 44 and inside the arrester plenum chamber 34 be increased from ambient pressure (typically 32.2 psi at sea level) to about 60 psi using room air, nitrogen N2, carbon-dioxide CO2, or other readily available gasses.

Thus, the gas charging process takes place inside the relatively small and easily environmentally-controlled pressure chamber 44 of the machine tool. It is not necessary to place the machine tool in a climate-controlled room at an elevated pressure in order to charge the plenum chamber 34 of the arrester assembly 38 up to a high pressure. It is also not necessary to fill that climate controlled room with nitrogen or other gasses specifically to charge the gas chamber 34. Accordingly, the present invention process and apparatus for making an arrester save much by way of material costs and manufacturing environment costs. And because the basic assembly process for the arrester takes place outside of the pressure chamber 44, there is no need for the production workers and technicians to be exposed to the higher pressures and charging gasses. Worker safety is maintained while labor costs are minimized. Finally, because the present invention machine tool does not require a pressurized, gas filled, climate-controlled room to function, it can be located on the shop floor. As a result, there is no need for workers, raw materials, and finished parts to enter or exit such a sealed room through an interfering barrier. Production throughput for the present invention machine tool and process and manufacturing efficiency are thus maximized.

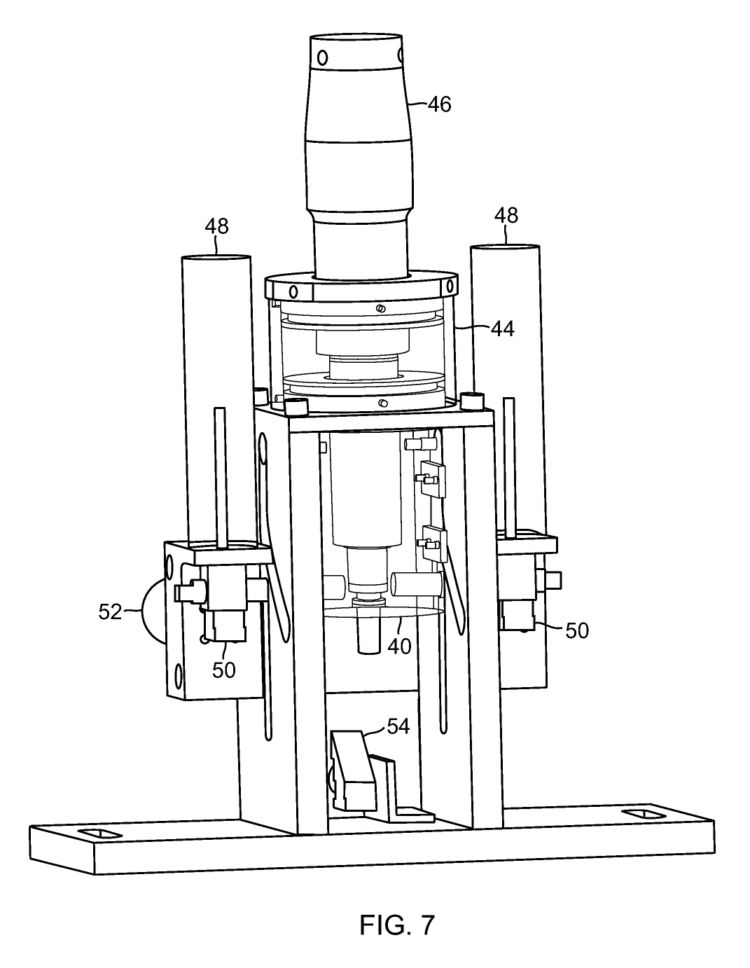

FIG. 7 depicts when ultrasonic welding horn 46 descends on the cap 12 of the arrester assembly 38 and ultrasonically welds the cap into place and captures the elevated pressure inside the plenum chamber 34 inside the arrester assembly 38. The ultrasonic weld prevents the pressurized gas inside the plenum chamber 34 of the arrester assembly 38 from escaping.

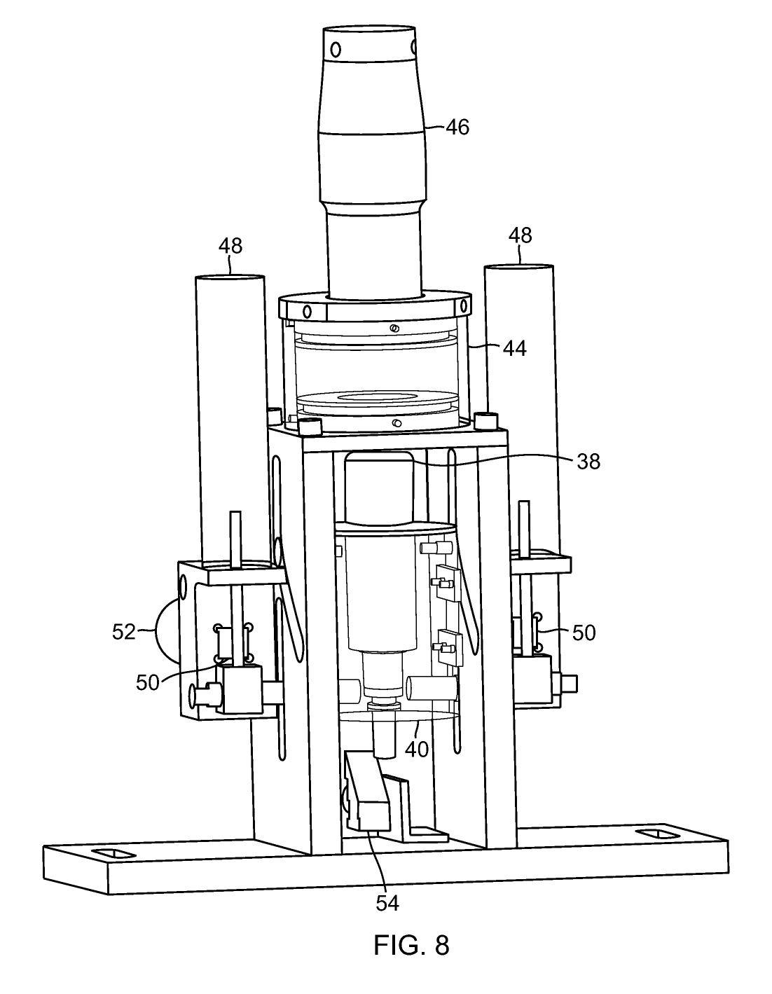

FIG. 8 shows post weld activity, where the ultrasonic welder horn 46 ascends out of the pressure chamber 44. Registration cylinders 52 pull locks 50 back and the carrier 40 holding the welded arrester assembly 38 withdraws its top end out of the pressure chamber 44, and the carrier 40 is lowered from pressure chamber 44 by cylinders 48.

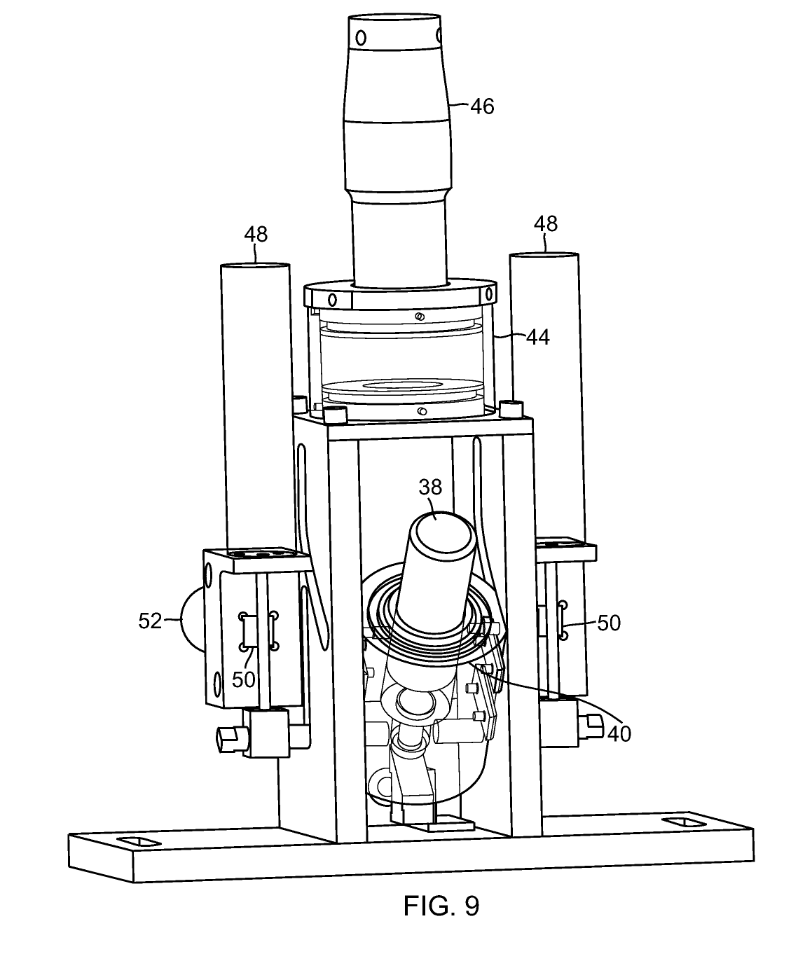

FIG. 9 shows when the carrier 40 is in its down position and ejection ramp 54 pushes the welded and pressurized arrester assembly 38 from the carrier. To facilitate this ejection, the carrier 40 swivels out of coaxial alignment. The finished arrester assembly 38 can be retrieved by a robot or manually, or can be ejected into a waiting bin. After the finished arrester assembly 38 is removed, a new, pre-weld, unpressurized arrester assembly is placed inside the carrier and the cycle begins again.

From the foregoing detailed description, it should be evident that there are a number of changes, adaptations and modifications of the present invention that come within the province of those skilled in the art. Features or structures of one embodiment may be combined with features or structures in another embodiment. However, it is intended that all such variations not departing from the spirit of the invention be considered as within the scope thereof except as limited solely by the following claims.

We claim:

1. A process for making a water hammer arrester having a hollow cylinder with an gas end and a liquid end, a piston slidable inside the cylinder, a cap disposed over the gas end wherein a plenum chamber is enclosed by the cap and the piston, and a pipe fitting extending from the liquid end, the process comprising:
providing a carrier slidable on a frame;
providing a pressure chamber having a first and second ends at one end of the frame;
providing an ultrasonic welding horn disposed at the first end of the pressure chamber;
wherein the carrier receives the water hammer arrester therein;
moving the carrier with the water hammer arrester toward the second end of the pressure chamber such that only a portion of the arrester and the cap are inserted into the pressure chamber;
increasing the pressure inside the pressure chamber to a pressure higher than outside the pressure chamber;
advancing the ultrasonic welding horn to engage at least the cap and the arrester cylinder;
ultrasonically welding the cap to the cylinder of the arrester sealing the plenum chamber closed at the pressure of the pressure chamber; and
withdrawing the carrier to retract the arrester out of the pressure chamber.

2. The process for making a water hammer arrester of claim 1, wherein the pressure chamber has an increased pressure of at least about 60 psi at room temperature.

3. The process for making a water hammer arrester of claim 1, wherein the cap, piston, and cylinder include a thermoplastic polymer.

4. The process for making a water hammer arrester of claim 1, wherein the cap, piston, and cylinder include an acetal based polymer.

5. The process for making a water hammer arrester of claim 1, wherein the step of increasing the pressure inside the pressure chamber simultaneously increases the pressure inside the plenum chamber.

6. The process for making a water hammer arrester of claim 1, wherein the frame includes opposed lifting cylinders moving the carrier toward and away from the pressure chamber.

7. The process for making a water hammer arrester of claim 1, wherein the arrester cylinder, the ultrasonic weld horn, and the pressure cylinder are aligned coaxially.

8. The process for making a water hammer arrester of claim 1, wherein the carrier pivots relative to the frame for loading and ejecting the arrester.

9. The process for making a water hammer arrester of claim 1, wherein after the step of increasing pressure inside the pressure chamber, the plenum chamber pressure is at the same pressure as the pressure chamber.

10. A process for making a water hammer arrester for damping a shock wave propagating inside a liquid medium within a pipe, the process comprising:
providing a carrier slidable on a frame;
providing a pressure chamber having first and second ends at one end of the frame;
providing a hollow cylinder with a gas end and a liquid end, a piston, and a cap having tabs;
assembling the hollow cylinder, piston, and cap together to create an arrester assembly outside of the pressure chamber, wherein the piston is slidable inside the cylinder and the cap is disposed over the gas end of the cylinder with a gap supported by the tabs, wherein a plenum chamber is formed between the cap and the piston;
providing an ultrasonic welding horn disposed at the first end of the pressure chamber;
wherein the carrier receives the arrester assembly therein;
moving the carrier with the arrester assembly toward the second end of the pressure chamber such that the gas end and only a portion of the arrester assembly and the cap are inserted into the pressure chamber;
increasing the pressure inside the pressure chamber to a pressure higher than outside the pressure chamber, wherein the pressure inside the plenum chamber is increased concurrently;
advancing the ultrasonic welding horn to engage at least one of the cap and the arrester cylinder, and forcing the cap to abut the gas end of the cylinder and closing the gap therebetween;
ultrasonically welding the cap to the cylinder of the arrester sealing the plenum chamber closed at the pressure of the pressure chamber; and
withdrawing the carrier to retract the arrester assembly out of the pressure chamber.

11. The process for making a water hammer arrester of claim 11, wherein process includes snap fitting a pipe fitting to the liquid end of the cylinder for connecting the arrester to the pipe.

12. The process for making a water hammer arrester of claim 11, wherein the process further includes mounting at least one O-ring to the piston outside of the pressure chamber.

13. The process for making a water hammer arrester of claim 11, wherein the ambient pressure inside the plenum chamber is the same as the ambient pressure inside the pressure chamber when the gas end, the portion of the arrester assembly, and the cap are inserted into the pressure chamber.

14. The process for making a water hammer arrester of claim 13, wherein the ambient pressure inside the plenum chamber is the same as the ambient pressure is inside the pressure chamber, and the ambient pressure is ≧about 60 psi at room temperature.

15. A water hammer arrester for damping a shock wave in a liquid-carrying pipe, comprising:
a hollow cylinder having a gas end and a liquid end;
a piston slidable within the hollow cylinder dividing the interior of the cylinder to a gas section and a liquid section, wherein the gas section is located adjacent the gas end;
an O-ring disposed on the piston to seal leakage of gas and liquid from the gas section and the liquid section;
a plug-shaped cap covering the gas end, wherein the piston, cap, and cylinder wall form a sealed plenum chamber at the gas section;
an ultrasonic weld joining the cap to the gas end of the cylinder and sealing closed the gas end to any gas leak;
at least one of nitrogen, air, and carbon-dioxide, contained inside the plenum chamber at a pressure of ≧about 60 psi at room temperature; and
a fitting mechanically joined to and extending from the liquid end, the fitting having a conduit therein in communication with the liquid section, and connected to the pipe.

16. The water hammer arrester of claim 15, wherein the fitting is made from a different material than the cylinder.

17. The water hammer arrester of claim 15, wherein the cap includes a plug shape having a plurality of spaced apart tabs at the base.

18. The water hammer arrester of claim 15, wherein the fitting is mechanically joined to the cylinder by a snap fit only without use of adhesives or a weld.
